(19) United States
(12) Patent Application Publication
(10) Pub. No.: US 2018/0322662 A1
(43) Pub. Date: Nov. 8, 2018

(54) METHOD FOR TRANSFER OF A STYLE OF A REFERENCE VISUAL OBJECT TO ANOTHER VISUAL OBJECT, AND CORRESPONDING ELECTRONIC DEVICE, COMPUTER READABLE PROGRAM PRODUCTS AND COMPUTER READABLE STORAGE MEDIUM

(71) Applicant: THOMSON Licensing, Issy-les-Moulineaux (FR)

(72) Inventors: Pierre HELLIER, Thorigné fouillard (FR); Oriel FRIGO, Rennes (FR); Neus SABATER, Betton (FR); Julie DELON, Paris (FR)

(21) Appl. No.: 15/774,003

(22) PCT Filed: Nov. 7, 2016
(86) PCT No.: PCT/EP2016/076868

§ 371 Date: May 5, 2018

(30) Foreign Application Priority Data
Nov. 6, 2015 (EP) 15306766.5

(51) Int. Cl. G06T 11/00

(52) U.S. Cl. CPC G06T 11/001

(57) ABSTRACT

The disclosure relates to a method for transferring a style of a reference visual object to an input visual object. According to an embodiment, the method includes finding a correspondence map assigning to a point in the input visual objet a corresponding point in the reference visual object, the finding of a correspondence map comprising spatially adaptive partitioning of the input visual object into a plurality of regions, the partitioning depending on the reference and input visual objects. The disclosure also relates to corresponding electronic device, computer readable program product and computer readable storage medium.

### 1. TECHNICAL FIELD The present disclosure relates to transfer of the style of a reference visual object to another visual object.

A method for transfer of the style of a reference visual object to another visual object, and corresponding electronic device, computer readable program products and computer readable storage medium are described.

### 2. BACKGROUND ART

Style transfer is the task of transforming an image in such a way that it resembles the style of a given example. This class of computational methods are of special interest in film post-production and graphics, where one could generate different renditions of the same scene under different “style parameters”. Here, we see the style of an image as a composition of different visual attributes such as color, shading, texture, lines, strokes and regions.

Style transfer is closely related to non-parametric texture synthesis and transfer. Texture transfer can be seen as a special case of texture synthesis, in which example-based texture generation is constrained by the geometry of an original image. Style transfer, for this part, can be seen as a special case of texture transfer, where one searches to transfer style from an example to an original image, and style is essentially modeled as a texture.

Texture synthesis by non-parametric sampling can be inspired by the Markov model of natural language [15], where text generation is posed as sampling from a statistical model of letter sequences (n-grams) taken from an example text. In an analogous manner, non-parametric texture synthesis can rely on sampling pixels directly from an example texture. It became a popular approach for texture synthesis [7] and for texture transfer [6, 11, 16] due to convincing representation of either non-structural and structural textures.

In the literature of texture synthesis and transfer, one can find two main approaches to compute non-parametric sampling in an image based Markov Random Field (MRF), that we call here respectively as the greedy and the iterative strategies. The first strategy considers texture synthesis as the minimization of greedy heuristic costs, and perform a neighborhood based MRF sampling to obtain a local solution. The non-parametric texture synthesis method of [7] takes a pixel to be synthesized by random sampling from a pool of candidate pixels selected from an example texture. The candidate pixels are those pixels in the example texture which neighborhood best matches the neighborhood of the pixel to be synthesized. A heuristic smoothness background solution has a simple principle: pixels that go together in the example texture should also go together in the synthesized texture. A similar approach was extended to patch-based texture synthesis and also for texture transfer in [6].

Note that in greedy approaches, a local solution is computed while scanning the image to be synthesized, therefore the result remains largely dependent of the scanning order.

We can find two main classes of style transfer methods in the literature, that we call as supervised and unsupervised approaches. One of the first methods to propose supervised style transfer posed the problem as computing an analogy given by A:A′::B:B′ [11]. In particular, a pixel to be synthesized in image B′ is directly selected from an example stylized image A, by minimizing a cost function that takes into account the similarity between B and A and the preservation of neighbor structures in A, in similar fashion to the texture transfer method of [2]. A similar supervised stylization approach was extended to video in [4], where the problem of temporal coherence in video style transfer is investigated. We note that supervised style transfer methods need a registered pair of example images A and A′ from which it is possible to learn a style transformation, however this pair of images is hardly available in practice. This is essentially different from an unsupervised approach.

In the literature, there are very few works dealing with unsupervised style transfer, Still borrowing from image analogies notation, the unsupervised scenario assumes that only an example image A and an original image B are given. In [14] the authors describe a Bayesian technique for inferring the most likely output image from the input image and the exemplar image. The prior on the output image P(B′) is a patch-based Markov random field obtained from the input image. The authors in [16] decompose original and example images into three additive components: draft, paint and edge. Then, the style is transferred from the example image to the input image in the paint and edge components. Style transfer is formulated as a global optimization problem by using Markov random fields, and a coarse-to-fine belief propagation algorithm is used to solve the optimization problem. Finally, the output image is recovered combining the draft component and the output of the style transfer.

In both [14] and [16], a MRF is defined for image patches of same size, disposed over a regular grid.

Example-based methods have been widely employed to solve problems such as texture synthesis [6], inpainting [18], and super-resolution [19], with state-of-the-art performance. These non-local and non-parametric approaches draw on the principle of self-similarity in natural images: similar patches (sub-images) are expected to be found at different locations of a single image.

It is of interest to propose efficient techniques for improving the result of transfer style, compared to the prior art transfer style solutions.

### 3. SUMMARY

The present principles propose a method for transferring a style of a reference visual object to an input visual object, the method comprising finding a correspondence map ϕassigning to at least one point x in the input visual objet a corresponding point ϕ(x) in the reference visual object.

Moreover, finding a correspondence map ϕ can comprise spatially adaptive partitioning of the input visual object (I) into a plurality of regions Ri, the partitioning depending on the reference and input visual objects.

Indeed, despite the practical success of patch-based methods for inverse problems, the patch dimensionality remains a sensitive parameter to tune in these algorithms. For instance, to obtain a coherent patch-based texture synthesis, patches should have approximately the same dimensionality of the dominant pattern in the example texture. The problem of patch dimensionality is also crucial for example-based style transfer. Patch dimensions should be large enough to represent the patterns that characterize the example (or reference) style, while small enough to forbid the synthesis of content structures present in the example (or reference) image.

At least one embodiment of the present disclosure can propose a solution for transferring a style of a reference (also named example) visual object, such as an image, a part of an image, a video or a part of a video, to an input visual object, in an unsupervised way helping capturing a style of the reference visual object while helping preserving the structure of the input visual object.

According to said embodiment, the “split and match” step can correspond to an adaptive strategy that may help obtaining convincing synthesis of styles, helping overcoming some of the scale problems found in some state-of-the-art example-based approaches, hence being helping capturing the style of the reference visual object while helping preserving the structure of the input visual object.

According to a particular feature, spatially adaptive partitioning can comprise quadtree splitting of the input visual object (I) into a plurality of regions Ri, delivering, for at least one region Ri, a set of K candidate labels Li, representing region correspondences between the input visual object (I) and the reference visual objet (E).

According to this embodiment, the method can use a “Split and Match” example-guided decomposition, using a quadtree splitting of the input visual object in regions (also called partitions or patches) as a strategy to reduce the dimensionality of the problem of finding the correspondence map, by reducing the dimensionality of possible correspondences. Indeed, decomposing an image into a suitable partition can have a considerable impact in the quality patch-based style synthesis.

Thus, a set of K candidate labels Lᵢ={lᵢ_{ₖ}}ₖ₌₁^{K} is first computed.

It is to be noted that regions/patches can be squares or rectangles.

For example, the stopping criteria for the quadtree splitting depends on the region similarity between the input and reference visual objects.

According to a particular feature, the method can comprise optimizing the set of K candidate labels Li using an inference model of Markov Random fields (MRF) type, delivering an optimized set of labels ̂L.

Thus, according to this embodiment, the method can use an inference model MRF for optimizing the set of candidate labels firstly computed.

Indeed, this can help obtaining smooth intensity transitions in the overlapping part of neighbor candidate regions (or patches), while also aiming to penalize two neighbor nodes, in the quadtree, as a strategy to boost local synthesis variety.

For example, the region similarity is computed according to a distance between a vector representation of a region in the input visual object and vector representation of a region in the reference visual object.

For example, the vector representation can be an output of neural network (like a convolutional neural network), from a region in the input visual object or a region in the reference visual object.

According to a particular feature, for a region Ri for which the stopping criteria is verified, a set of candidate labels is selected by computing the K-nearest neighbors of a region in the reference visual object E corresponding to the region Ri.

Thus, according to this embodiment, a set of candidate labels can be found for all nodes of the quadtree, even a “leaf node”.

Moreover, the method comprises solving the MRF inference model by approximating a Maximum a Posteriori using a loopy belief propagation type method, delivering the approximate marginal probabilities for at least two variables of the MRF model (for instance, for all variables of the MRF model).

Thus, according to this embodiment, using the Loopy Belief Propagation method allows computing the approximate marginal probabilities (beliefs) of all the variables in a MRF, usually after a small number of iterations.

Indeed, neighboring variables update their likelihoods by message, thanks to a simple and efficient algorithm.

According to a particular feature, the method comprises replacing at least one region Ri of the input visual object by an optimized corresponding region of the reference visual object, delivering at least one replaced quadtree region Ri.

According to a particular feature, the method comprises applying a bilinear blending on the quadtree regions.

Thus, according to this embodiment, the method uses a Bilinear blending of quadtree regions/patches previously obtained, in order to remove visible seams. This can help obtaining smooth color transitions between neighbor regions/patches at a very low computational cost.

Thus, once regions/patches are matched (after the first two steps previously described), a bilinear blending is used at the regions/patches boundaries so as to ensure a maximal spatial coherence of the method.

For example, bilinear blending comprises, for a replaced quadtree region:
obtaining an overlapping quadtree by increasing the size of the replaced quadtree region by an overlap ratio;
computing a blended pixel u′(x) in the output visual object as a linear combination of all overlapping intensities at x.

According to a particular feature, the method further comprises for at least one region Ri, selecting an optimal corresponding region of the reference visual object, wherein the selecting can notably take into account the size, the color and/or the shape of the region Ri of the input visual object and/or the size, the color and/or the shape of the corresponding region of the reference visual object.

For example, a visual object corresponds to an image or a part of an image or a video or a part of a video.

According to another aspect, the present disclosure relates to an electronic device comprising at least one memory and one or several processors configured for collectively transferring the style of a reference visual object to an input visual object.

According to at least on embodiment of the present disclosure, said one or several processors are configured for collectively:
finding a correspondence map ϕ assigning to at least one point x in the input visual objet a corresponding point ϕ(x) in the reference visual object, said finding of a correspondence map ϕ comprising spatially adaptive partitioning of said input visual object (I) into a plurality of regions Ri, said partitioning depending on said reference and input visual objects.

According to another aspect, the present disclosure relates to a non-transitory program storage device, readable by a computer.

According to another aspect, the present disclosure relates to a non-transitory computer readable program product comprising program code instructions for performing the method of the present disclosure, in any of its embodiments, when said software program is executed by a computer.

Notably, at least on embodiment of the present disclosure relates to a non-transitory computer readable program product comprising program code instructions for performing, when said non-transitory software program is executed by a computer, a method for transferring a style of a reference visual object (E) to an input visual object (I), wherein the method comprises finding a correspondence map ϕ assigning to at least one point x in the input visual objet a corresponding point ϕ(x) in the reference visual object, said finding of a correspondence map ϕ comprising spatially adaptive partitioning of said input visual object (I) into a plurality of regions Ri, said partitioning depending on said reference and input visual objects.

According to another aspect, the present disclosure relates to a computer readable storage medium carrying a software program comprising program code instructions for performing the method of the present disclosure, in any of its embodiments, when said software program is executed by a computer.

Notably, at least on embodiment of the present disclosure relates to a computer readable storage medium carrying a software program comprising program code instructions for performing, when said non-transitory software program is executed by a computer, a method for transferring a style of a reference visual object (E) to an input visual object (I), wherein the method comprises finding a correspondence map ϕ assigning to at least one point x in the input visual objet a corresponding point ϕ(x) in the reference visual object, said finding of a correspondence map ϕ comprising spatially adaptive partitioning of said input visual object (I) into a plurality of regions Ri, said partitioning depending on said reference and input visual objects.

### 4. LIST OF DRAWINGS

The present disclosure will be better understood, and other specific features and advantages will emerge upon reading the following description, the description making reference to the annexed drawings wherein:

FIG. 1 illustrates an input visual object, a reference (or in other word exemplary) visual object and a resulting output visual object according to at least one particular embodiment of the present disclosure;

FIG. 2 illustrates MRF for low-level vision problems over a regular grid according to at least one particular embodiment of the present disclosure;

FIG. 3 illustrates MRF over an adaptive image partition according to at least one particular embodiment of the present disclosure;

FIG. 4 illustrates style transfer for different sketch styles, according to at least one particular embodiment of the method of the present disclosure;

FIG. 5 is a functional diagram that illustrates a particular embodiment of the method of the present disclosure;

FIG. 6 illustrates an electronic device according to at least one particular embodiment of the present disclosure;

FIG. 7 is a functional diagram that illustrates a particular embodiment of the method of the present disclosure.

### It is to be noted that the drawings have only an illustration purpose and that the embodiments of the present disclosure are not limited to the illustrated embodiments.

### 5. DETAILED DESCRIPTION OF THE EMBODIMENTS

At least some principles of the present disclosure relate to a transfer of a style of a reference visual object to an input visual object.

A visual object can be for instance an image and/or a video.

At least an embodiment of the method of the present disclosure relates to an example-based style-transfer. The proposed method transfers the image style of an exemplar image E to an input image I in order to get an output image 0 with the geometry of I but the style of E.

Notably, according to some embodiments of the present disclosure, content and style can be naturally decomposed in a spatially adaptive image partition. Such an adaptive strategy can help obtaining convincing synthesis of styles, that help overcoming some scale problem fond in some state-of-the-art example-based approaches.

Some embodiments of the present disclosure can be based on an example-based adaptive image solution.

In some embodiments of the present disclosure the input image is decomposed according to a spatial decomposition.

Some embodiments of the present disclosure can use an iterative strategy which considers an explicit probability density modelling of the problem and compute an approximate

Maximum a Posteriori (MAP) solution through algorithms such as message passing or graphcuts.

According to the primal sketch theory of visual perception [13], an image may be seen as a composition of structures: an ensemble of noticeable primitives or tokens; and textures: an ensemble with no distinct primitives in preattentive vision. Inspired by this principle, [8] presented a generative model for natural images that operates guided by these two different image components, that they called as sketchable and non-sketchable parts.

In this work, we adopt a similar view for example-based style synthesis. The inventors have made the observation that the visual elements accounting for distinctive painting style in fine arts are often anisotropic with respect to scale. In other words, details corresponding to the geometry (or the sketchable part) of a scene are often painted carefully with fine brushwork, while the scene non-sketchable part is sometimes painted with rougher brushes, where brushwork style is usually more distinct. This observation can hold more importantly for some particular artistic styles such as impressionism and post-impressionism than other painting styles such as realism.

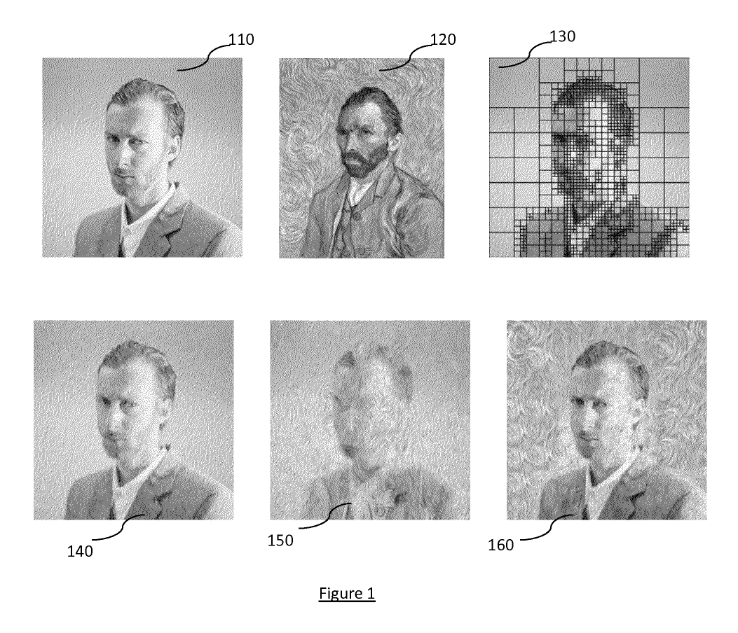

We remind that in texture transfer, pixel-based models have assumed neighborhoods with regular size, and patch-based methods similarly assume an image decomposition into regularly sized patches. As illustrated in FIG. 1, a regular grid assumption is problematic for style transfer. In general, if the patches 130 in a regular grid are small (for instance of size 8×8), a more or less realistic reconstruction 140 of the original image 110 can be achieved, but the style of the example image 120 is hardly noticeable. On the other hand, for larger patch size, the style from the example image 120 can be noticed in the reconstructed image 150, however the fine geometry of the original image 110 is not correctly reconstructed.

In order to overcome this limitation, at least one embodiment of the method of the present disclosure takes into account the scale problem in stylization. Element 160 of FIG. 1 illustrates a reconstruction obtained from an embodiment of the present disclosure. In the following subsections, we give a formal definition for unsupervised style transfer and our proposed solution to the problem.

Let u:106 ᵤ→R³ be an original image and v:Ωᵥ→R³ an example style image. In the original image, a patch (or in other word a region) of size τ×τ centered at u(x) as pᵤ(x)=u(x+B), with B a square centered at x. A patch can be defined in a similar way in the example style image. In similar fashion to the variational formulation of example-based inpainting [1], style transfer can be posed as finding a correspondence map ϕ:Ωᵤ→Ωᵥ which assigns to each point x∈Ωᵤ in the original image domain a corresponding point ϕ(x)∈Ωᵥ in the example image domain. Then, a simple formulation of style transfer searches for the correspondences ϕ that minimize

$$ɛ ( φ ) = {\int }_{{Ω}_{u}} {\vert {p}_{v} ( φ ( x ) ) - {p}_{u} ( x ) \vert}^{2} dx \qquad ( 1 )$$

and style transfer can be computed by reconstructing an output image û with the intensities of v, as given by

û(x)=v(ϕ(x)) (2)

However, without any constraints on 1:1), there is no guarantee that the reconstruction in Equation (2) will achieve noticeable transfer of texture features from v (We observed experimentally that approximating the solution of Equation (1) by exhaustive patch matching between u and v, ̂u results in a patch-wise color or luminance transfer). Hence, we constrain ϕ to be a roto-translation map with {Rhᵢ}_{i∈l} a reasonable partition of Ωᵤ:

$$φ ( x ) = {\sum }_{i = 1}^{n} {T}_{i} ( x - {t}_{i} ) {R}_{i} ( x ) . \qquad ( 3 )$$

In at least some embodiment, the partition {Rhᵢ}_{i∈l} can play an important role in style transfer. For simplicity of exposition, we assume for now that regions {Rhᵢ}_{i∈l} are known and τ₁=Id. Reformulating the problem in terms of regions, we search to minimize

$$ɛ ( {t}_{1} , … , {t}_{n} ) = {λ}_{d} {\sum }_{i = 1}^{n} {\int }_{{R}_{i}} {\vert {p}_{u} ( x ) - {p}_{v} ( x + {t}_{i} ) \vert}^{2} dx + \text{?} {\vert {p}_{v} ( x + {t}_{i} ) - {p}_{v} ( x + {t}_{j} ) \vert}^{2} dx - {λ}_{r} {\int }_{x ∈ S ( {R}_{i} , {R}_{j} )} {\vert ( x + {t}_{i} ) - ( x + {t}_{j} ) \vert}^{2} dx \\ \text{?} \text{indicates text missing or illegible when filed} \qquad ( 4 )$$

However, we note that no effective solution is known to directly minimize the non-convex energy in Equation (4). An effective approach in example-based methods can consist in search for a greedy solution to the probabilistic graphic model equivalent to the variational formulation.

In at least some embodiments, a proposed algorithm to find an approximate solution to the partition problem and to Equation (4) can comprise splitting the task into simple sub problems. The algorithm can be based for instance (at least partially) on the steps below:
Solve for R by computing an adaptive partition;
MRF model: Optimal labelling by message passing;
Bilinear blending of quadtree patches.

In the first step, we solve for partition R while reducing the dimensionality of possible correspondences in 1:1). For that, we truncate the domain of possible correspondences to a smaller set of candidate labels L={Rhᵢ}_{i∈l}, L⊂Ωᵥ. In the sequence, we solve a correspondent probabilistic labelling problem by an iterative message passing approach.

In at least some embodiment, decomposing an image into a suitable partition can have a considerable impact in the quality patch-based style synthesis. We propose an approach, that can be simple yet effective in at least some embodiments, based on a modified version of a Split and Merge decomposition [12]. In this approach, the local variance of a quadtree cell can be used to decide whether a cell will be splitted into four cells. Here we propose a “Split and Match” example-guided decomposition, where the stopping criteria for quadtree splitting depends also on the patch similarity between the input and example images.

In the particular embodiment detailled, a region Rᵢ is a square of size τᵢ², and pᵤ(xᵢ):Rᵢ→R³ is a quadtree patch over Rᵢ, so that pᵤ(xᵢ)=u(Rᵢ). The decomposition starts with one single region R₁:=Ωᵤ. Each region Rᵢ of the partition is splitted into four equal squares, each one of size

$${( \frac{{T}_{i}}{2} )}^{2} ,$$

until a patch in the example image v matches u(Rᵢ) with some degree of accuracy.

Since quadtree patches can have arbitrary size, we use normalized distances for patch comparison. More precisely, the distance between two patches pᵤ(xᵢ) and pᵥ(y) of size τᵢ² is defined as

$$d [ {p}_{u} ( {x}_{i} ) , {p}_{v} ( y ) ] = \frac{{‖ {p}_{u} ( {x}_{i} ) - {p}_{v} ( y ) ‖}^{2}}{{T}_{i}^{2}} . \qquad ( 5 )$$

Now, if yᵢ is the best correspondence of xᵢ in vat this scale τᵢ:

yᵢ:=y::d[pᵤ(xᵢ),pᵥ(y)] (6)

the region Rᵢ is splitted in four regions if the following condition is satisfied

ζ(pᵤ(xᵢ),pᵥ(yᵢ))=(σᵢ²;d[pᵤ(xᵢ),pᵥ(yᵢ)]<ω::and::τᵢ<Y₀)::or::τᵢ<Y₁ (7)

where σᵢ²=Var(pᵤ(xᵢ)) is the variance of pᵤ (xᵢ), ω is a similarity threshold, Y₀ is the minimum patch size and Y₁ the maximum patch size allowed in the quadtree.

Observe that Rᵢ is not encouraged to be splitted if there is at least one patch pᵥ(y) which is similar enough to pᵤ(xᵢ), unless the variance of the patch σᵢ² is large.

Eventually, for every “leaf node” of the quadtree (nodes for which the splitting condition in (3) is not satisfied), a set of K candidate labels Lᵢ{lᵢ_{ₖ}}ₖ₌₁^{K} is selected for Rᵢ by computing the K-nearest neighbors {pᵥ(lᵢ_{ₖ})}ₖ₌₁^{K} of pᵤ(xᵢ) in v.

An examplary whole split and match step is summarized in Algorithm1. Of course different algorithms can be defined depending upon embodiments of the present disclosure.

Algorithm 1 “Split and Match” patch decomposition

```
Require: Images: u, v; parameters: φ₀, φ₁, w
Ensure: Set of regions R = {Rᵢ}ᵢ₌₁ⁿ, sets of labels L =
    {Lᵢ}ᵢ₌₁ⁿ
  1: Initialization: R₁ ← {Ω}
  2: for every region Rᵢ ∈ R do
  3: xᵢ ← center of Rᵢ
  4: σᵢ² ← Var(pᵤ(xᵢ))
  5: Compute yᵢ = arg min d[pᵤ(xᵢ),pᵥ(y)]
  6: if ζ(pᵤ(xᵢ),pᵥ(yᵢ))^{y} is true then
  7: Split Rᵢ into four:
  8: m ← ♯R − 1
  9: R ← {R \ Rᵢ} ∪ {Rₘ₊₁,...,Rₘ₊₄}
10: else
11: Assign labels to Rᵢ:
12: Lᵢ ← {lᵢ_{ₖ}}ₖ₌₁^{K}
13: end if
14: end for
```

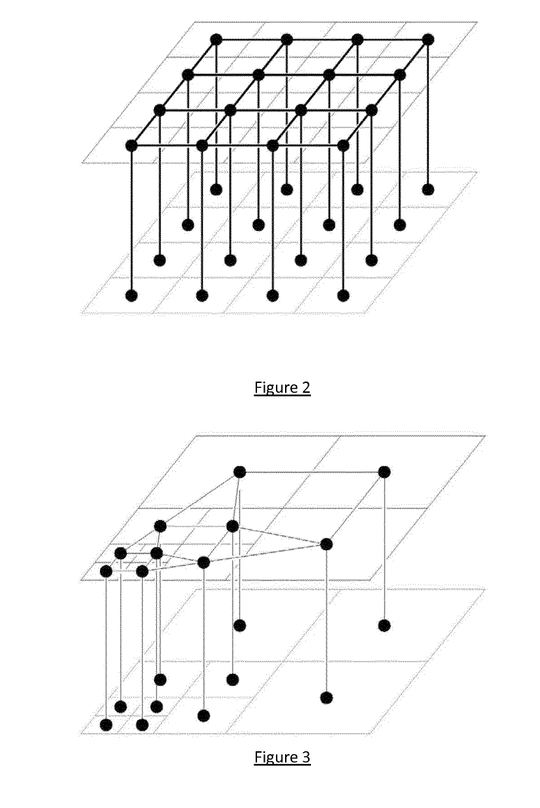

Markov Random Fields (MRF) is an inference model for computer vision problems [10], used to model texture synthesis [17] and transfer [6]. Within this model, the problem of example-based style transfer is solved by computing the Maximum a Posteriori sampling from the joint probability distribution of image units, (quadtree patch labels in our model). Usually, patch-based MRF models such as in [9] are computed over a graph in a regular grid, as illustrated in FIG. 2.

FIG. 2 illustrates MRF for low-level vision problems over a regular grid. Nodes in the bottom layer can represent image units from the observed scene, while nodes in the top layer can represent hidden image units that we search to estimate through inference. The vertical edges can represent data fidelity terms, while the horizontal edges can represent pairwise compatibility terms.

In a particular embodiment of the present disclosure, a MRF model over an adaptive partition can be used, as shown in FIG. 3. The neighborhood definition in the proposed quadtree MRF can be analogous to a 4-neighborhood in a regular grid.

In particular, we consider here an inference model to compute the most likely set of label assignments for u, where labels are essentially patch correspondences between u and v. As already discussed, for a quadtree patch pᵤ(xᵢ):Rᵢ→R³, we first compute a set of K candidate labels Lᵢ{lᵢ_{ₖ}}ₖ₌₁^{K} as a strategy to reduce the dimensionality of the problem. Now, we compute the optimal (or in other words optimized) set of labels ̂L={lᵢ}ᵢ₌ᵢⁿ, where the probability density we search to maximize can be written as [10]

$$P ( L ) = \frac{1}{Z} {\prod }_{i} ϕ ( {L}_{i} ) {\prod }_{( i , j )} Ψ ( {L}_{i} , {L}_{j} ) , \qquad ( 8 )$$

where Z is a normalization constant,

φ(lᵢ)=exp(−d[pᵤ(xᵢ),pᵥ(lᵢ)]λ_{d}) (9)

is the data evidence term, which measures the fidelity between pᵤ(xᵢ) and pᵥ(lᵢ), and λ_{d} is a data weighting parameter.

We model the pairwise compatibility term between neighboring nodes i and j of MRF by

ψ(lᵢ,lⱼ)=exp(−d[pᵥ~(lᵢ),pᵥ~(lⱼ)]λₛ+|lᵢ−lⱼ|²λᵣ) (10)

where λₛ is a smoothness weighting, and λᵣis a label repetition weighting parameter. In patch-based MRFs, the compatibility term ensures that neighbor candidate patches are similar in their overlapping region, here we denote~ lᵢ and~ lⱼ as labels corresponding to the overlapping region Rᵢ∩Rⱼ between quadree patches pᵤ(xᵢ) and pᵤ(xⱼ). In at least some embodiment, while we search for smooth intensity transitions in the overlapping part of neighbor candidate patches, we also aim to penalize two neighbor nodes to have exactly the same label, thus we encourage |lᵢ-lⱼ|² to be great as a strategy to boost local synthesis variety.

Note that computing an exact Maximum a Posteriori (MAP) inference to solve directly Equation (8) is an intractable combinatorial problem due to the high dimensionality of image based graphical models, but approximate solutions can be found by iterative algorithms. We adopt in this work the Loopy Belief Propagation method [Weiss1997] [Pearl 1988] for approximate inference, for being a simple and efficient algorithm. Basically, neighboring variables update their likelihoods by message passing and usually after a small number of iterations, the approximate marginal probabilities (beliefs) of all the variables in a MRF are computed [9].

It is well known that a MAP problem can be converted into an energy minimization problem [20] by taking the negative logarithm of Equation (8). By doing so, the resulting error function can be seen as a discrete version of Equation (4) for which we can compute an approximate minimum through the min-sum version of belief propagation. In practice, converting the MAP inference into an energy minimization problem has two implementation advantages: avoiding the computation of exponentials; representation of energies with integer type, which is not possible for probabilities.

Despite we compute label correspondences that are likely to be coherent across overlapping regions, seams can still be noted in the reconstructed image û, notably across the quadtree patch boundaries. In a patch-based reconstruction method, blending can be a strategy for removal of visible seams, either through minimal boundary cut or alpha blending strategies.

In at least some embodiment, a method inspired on linear alpha blending can be applied. For that, we consider an overlapping quadtree by increasing the size of every quadtree patch by Θτ, where Θ is the overlap ratio. A blended pixel u′¹(x) in the final reconstructed image is computed as a linear combination of at least two overlapping intensities (for instance of all overlapping intensities) at x:

$${u}^{′} ( x ) = {\sum }_{i}^{n} {α}_{i} ( x ) \hat{u} ( x ) , \qquad ( 11 )$$

where α₁(x) is a weighting factor given by:

$${∝}_{i} ( x ) = \frac{δ ( x , \partial {p}_{i} )}{{Σ}_{1}^{n} δ ( x , \partial {p}_{i} )} if {Σ}_{1}^{n} δ ( x , \partial {p}_{i} ) > 0 and \\ {∝}_{i} ( x ) = \frac{1}{n} otherwise \qquad ( 12 )$$

and δ(x,∂pᵢ) gives the distance between point x and the patch border ∂pᵢ:

$$δ ( x , \partial {p}_{i} ) = \frac{{\vert x - \partial {p}_{i} \vert}^{2}}{{τ}_{i}^{2}} . \qquad ( 13 )$$

In practice, such a blending strategy can help obtaining smooth color transitions between neighbor patches at a very low computational cost.

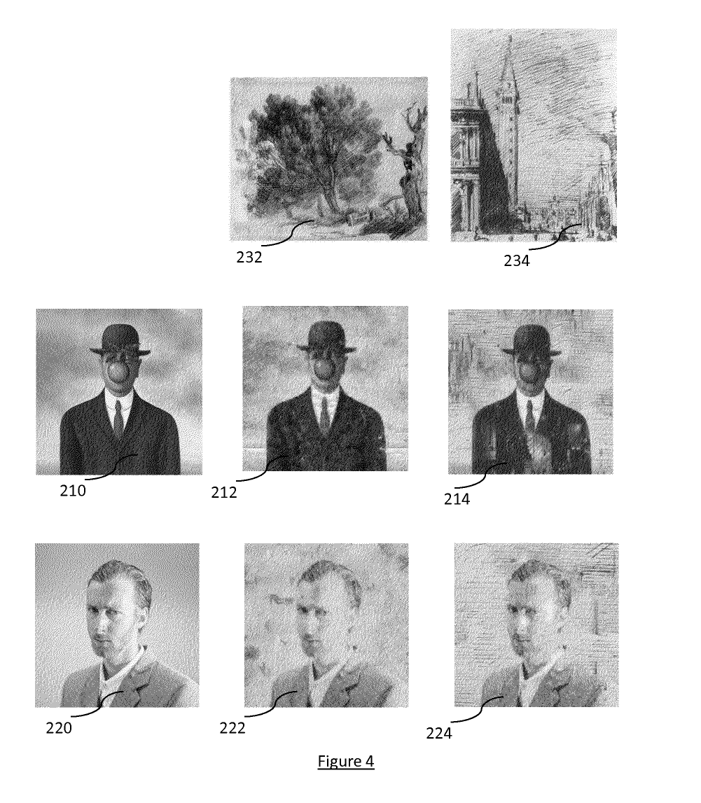

A number of experiments performed with our method is presented in link with FIG. 4, which illustrates an Example-based style transfer for sketches. Reconstructions 212, 214, 222, 224 of the input image 210, 220 are performed according to the examplar sketches 232, 234.

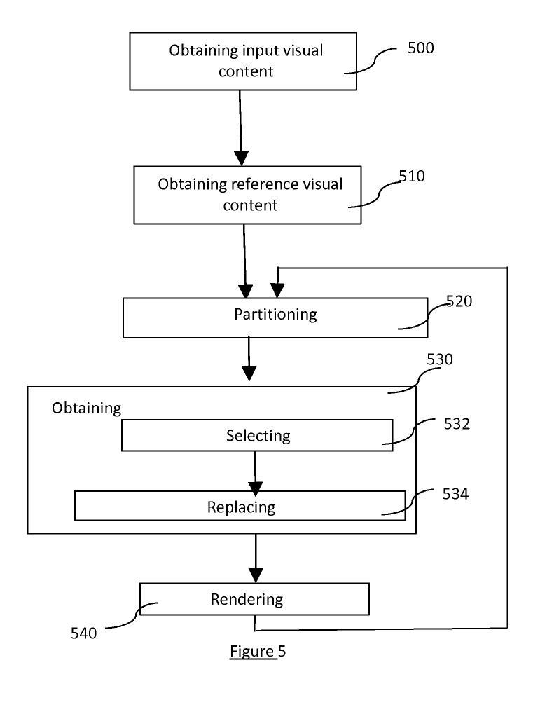

FIG. 5 describes a particular embodiment of the method of the present disclosure. In the exemplary embodiment described, the method is an unsupervised method.

In at least some embodiment of the method of the present disclosure, the experiment texture can be transferred from the example image, with the chromaticity of the original image being preserved.

As illustrated by FIG. 5, the method can comprise obtaining 500 an input visual object and obtaining 510 a reference visual object. The method also comprises partitioning 520 each visual object obtained in patches (like in square patches). According to FIG. 5, the method comprises obtaining 530 an output visual object according to the obtained input and reference contents. Obtaining the output (transformed) visual object can comprise, for at least one patch of the input visual object, selecting 532 a patch of the reference visual object and replacing 534 the patch of the input visual object by the selected patch of said reference visual object.

The selecting 532 can notably take into account the size, the color and/or the shape of said patch of said input and/or reference visual object.

As illustrated by FIG. 5, the method can comprise rendering 540 of at least one visual object. Depending upon embodiments, the rendering can comprise a rendering of the input visual object, the reference visual object and/or the output visual object. The rendering can comprise displaying at least one of the above information on a display on the device where the method of the present disclosure is performed, or printing at least one of the above information, and/or storing at least one of the above information on a specific support. This rendering is optional.

According to another embodiment of the present disclosure (that can eventually be combine with the above embodiment), the method can comprise:
Split and match adaptive decomposition
Optimal labeling by Loopy belief propagation
Seamless blending of quadtree patches

The style transfers rely heavily on the image decomposition. Classical methods fall into the following pitfalls:
A regular partitioning based on small patches would be fine to preserve the image structure, but would be inadequate to capture and transfer the style
A regular partitioning based on large patches would capture the style, at the cost of destroying image structure
Any partition based on the image content only would not be optimal for matching, since some patches would be impossible to match correctly in the example image.

At the opposite, according to at least one embodiment of the present disclosure, the method can comprise an image partitioning scheme that is adaptive, hence being able to capture the style while preserving the structure.

According to at least one embodiment of the present disclosure, the method can depend on the pair input/example images, what means that the partition is suited for a correct matching.

The patch matching problem, based on the adaptive partition, can be formulated using a Markov Random Field modeling, and solved using a Belief Propagation technique [6].

Once patches are matched, so as to ensure a maximal spatial coherence of the solution, a bilinear blending is used at the patch boundaries.

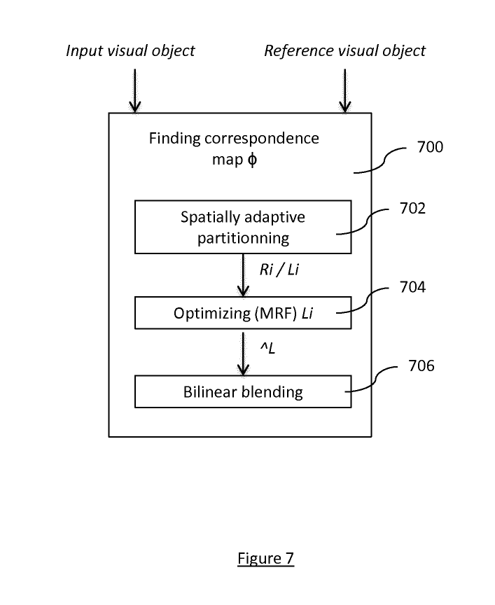

FIG. 7 describes a particular embodiment of the method of the present disclosure, for transferring a style of a reference visual object (E) to an input visual object (I). In the exemplary embodiment described, the method is an unsupervised method.

As illustrated by FIG. 7, the method can comprise finding 700 a correspondence map ϕ that assigns to at least one point x in the input visual objet (I) a corresponding point ϕ(x) in the reference visual object (E).

According to this embodiment, finding a correspondence map ϕcan comprise spatially adaptive partitioning 702 of the input visual object (I) into a plurality of regions Ri (also called patches), partitioning depending on the reference (E) and input (I) visual objects. According to a variant of this embodiment, adaptive partitioning can correspond to a quadtree splitting delivering, for at least one region, a set of K candidate labels Li, representing correspondences between this region of the input visual object (I) and regions of the reference visual objet (E). According to FIG. 7, the method also can comprise optimizing 704 the set of K candidate labels Li, delivering an optimized set of labels ̂L, thus allowing matching regions of the input visual objet (I) and regions of the reference visual object (E).

As illustrated by FIG. 7, the method can then comprise applying a bilinear blending 706 on the quadtree regions, once matched. This can help obtaining smooth color transitions between neighbor regions/patches at a very low computational cost.

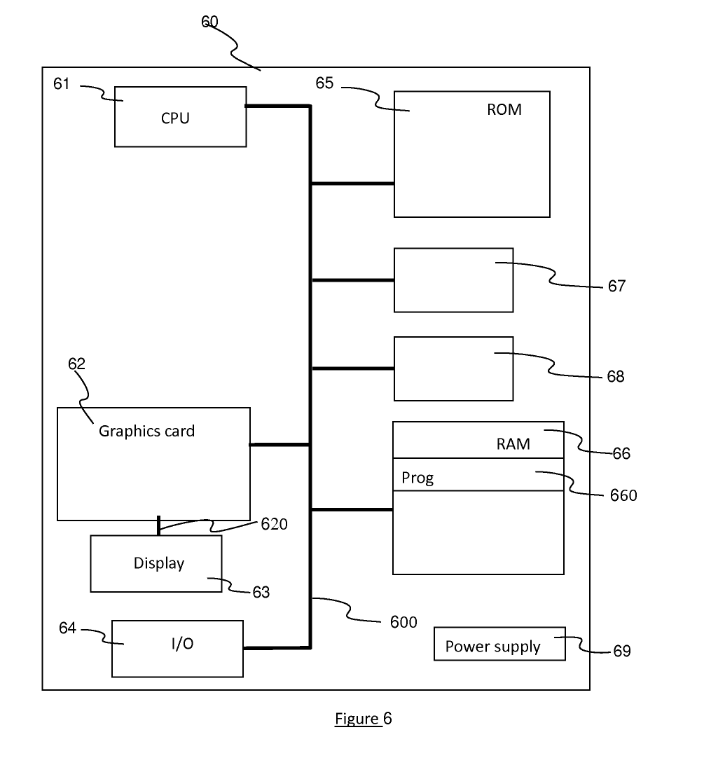

FIG. 6 describes the structure of an electronic device 60 configured notably to perform any of the embodiments of the method of the present disclosure.

The electronic device can be any image and/or video content acquiring device, like a smart phone or a camera. It can also be a device without any video acquiring capabilities but with video processing capabilities. In some embodiment, the electronic device can comprise a communication interface, like a receiving interface to receive a video and/or image content, like a reference video and/or image content or an input video and/or image content to be processed according to the method of the present disclosure. This communication interface is optional. Indeed, in some embodiments, the electronic device can process video and/or image contents, like video and/or image contents stored in a medium readable by the electronic device, received or acquired by the electronic device.

In the particular embodiment of FIG. 6, the electronic device 60 can include different devices, linked together via a data and address bus 600, which can also carry a timer signal. For instance, it can include a micro-processor 61 (or CPU), a graphics card 62 (depending on embodiments, such a card may be optional), at least one Input/Output module 64, (like a keyboard, a mouse, a led, and so on), a ROM (or «Read Only Memory») 65, a RAM (or «Random Access Memory») 66. In the particular embodiment of FIG. 6, the electronic device can also comprise at least one communication interface 67 configured for the reception and/or transmission of data, notably video data, via a wireless connection (notably of type WIFI® or Bluetooth®), at least one wired communication interface 68, a power supply 69. Those communication interfaces are optional.

In some embodiments, the electronic device 60 can also include, or be connected to, a display module 63, for instance a screen, directly connected to the graphics card 62 by a dedicated bus 620. Such a display module can be used for instance in order to output (either graphically, or textually) information, as described in link with the rendering step 540 of the method of the present disclosure.

In the illustrated embodiment, the electronic device 60 can communicate with a server (for instance a provider of a bank of reference images) thanks to a wireless interface 67. Each of the mentioned memories can include at least one register, that is to say a memory zone of low capacity (a few binary data) or high capacity (with a capability of storage of an entire audio and/or video file notably).

When the electronic device 60 is powered on, the microprocessor 61 loads the program instructions 660 in a register of the RAM 66, notably the program instruction needed for performing at least one embodiment of the method described herein, and executes the program instructions.

According to a variant, the electronic device 60 includes several microprocessors. According to another variant, the power supply 69 is external to the electronic device 60. In the particular embodiment illustrated in FIG. 6, the microprocessor 61 can be configured for an electronic device comprising at least one memory and one or several processors configured for collectively transferring a style of a reference visual object to an input visual object.

Notably, in at least some embodiment of the present disclosure, the one or several processors can be configured for collectively:
finding a correspondence map ϕ assigning to at least one point x in the input visual objet a corresponding point ϕ(x) in the reference visual object, finding a correspondence map ϕ comprising spatially adaptive partitioning of the input visual object (I) into a plurality of regions Ri, the partitioning depending on the reference and input visual objects.

As will be appreciated by one skilled in the art, aspects of the present principles can be embodied as a system, method, or computer readable medium. Accordingly, aspects of the present disclosure can take the form of a hardware embodiment, a software embodiment (including firmware, resident software, micro-code, and so forth), or an embodiment combining software and hardware aspects that can all generally be referred to herein as a “circuit”, “module” or “system”. Furthermore, aspects of the present principles can take the form of a computer readable storage medium. Any combination of one or more computer readable storage medium(s) may be utilized.

A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing.

It is to be appreciated that the following, while providing more specific examples of computer readable storage mediums to which the present principles can be applied, is merely an illustrative and not exhaustive listing as is readily appreciated by one of ordinary skill in the art: a portable computer diskette, a hard disk, a read-only memory (ROM), an erasable programmable read-only memory (EEPROM or Flash memory), a portable compact disc read-only memory (CD-ROM), an optical storage device, a magnetic storage device, or any suitable combination of the foregoing.

Thus, for example, it will be appreciated by those skilled in the art that the block diagrams presented herein represent conceptual views of illustrative system components and/or circuitry of some embodiments of the present principles. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope of the present principles. All such changes and modifications are intended to be included within the scope of the present principles as set forth in the appended claims.

At least some embodiment of the style transfer method of the present disclosure, can be applied in a consumer context, for instance for providing a new tool for image editing, more powerful than just color transfer, and more powerful than tools like Instagram® where image filters are defined once and for all.

At least some embodiment of the style transfer method of the present disclosure, can be applied in a (semi)-professional context, for instance for providing a tool to be used to perform image manipulation and editing in an interactive manner, like for pre-editing or pre-grading before a manual intervention.

### REFERENCES

[1]P. Arias, G. Facciolo, V. Caselles, and G. Sapiro. A variational framework for exemplar-based image inpainting. International Journal of Computer Vision, 93(3):319-347, 2011.
[2]M. Ashikhmin. Synthesizing natural textures. In Proceedings of the 2001 Symposium on Interactive 3D Graphics, I3D '01, pages 217-226, New York, N.Y., USA, 2001. ACM.
[3]C. Barnes, F.-L. Zhang, L. Lou, X. Wu, and S.-M. Hu. Patchtable: Efficient patch queries for large datasets and applications. In ACM Transactions on Graphics (Proc. SIGGRAPH), August 2015.
[4]P. Benard, F. Cole, M. Kass, I. Mordatch, J. Hegarty, M. S. Senn, K. Fleischer, D. Pesare, and K. Breeden. Stylizing animation by example. ACM Trans. Graph., 32(ϕ:119:1-119:12, July 2013.
[5]L. Cheng, S. Vishwanathan, and X. Zhang. Consistent image analogies using semi-supervised learning. In IEEE Conference on Computer Vision and Pattern Recognition (CVPR), 2008.
[6]A. A. Efros and W. T. Freeman. Image quilting for texture synthesis and transfer. In Proceedings of the 28th Annual Conference on Computer Graphics and Interactive Techniques, SIGGRAPH '01, pages 341-346, New York, N.Y., USA, 2001. ACM.
[7]A. A. Efros and T. K. Leung. Texture synthesis by non-parametric sampling. In Proceedings of the International Conference on Computer Vision-Volume 2-Volume 2, ICCV '99, pages 1033, Washington, D.C., USA, 1999. IEEE Computer Society.
[8]C. en Guo, S. C. Zhu, and Y. N. Wu. Towards a mathematical theory of primal sketch and sketchability. In ICCV 2003, 2003.
[9]W. Freeman, E. Pasztor, and O. Carmichael. Learning low-level vision. International Journal of Computer Vision, 40(1):25-47,2000.
[10] S. Geman and D. Geman. Stochastic relaxation, gibbs distributions, and the bayesian restoration of images. IEEE Trans. Pattern Anal. Mach. Intell., 6(6):721-741, November 1984.
[11] A. Hertzmann, C. E. Jacobs, N. Oliver, B. Curless, and D. H. Salesin. Image analogies. In Proceedings of the 28th Annual Conference on Computer Graphics and Interactive Techniques, SIGGRAPH '01, pages 327-340, New York, N.Y., USA, 2001. ACM.
[12] S. Horowitz and T. Pavlidis. Picture segmentation by a directed split and merge procedure. pages 424-433,1974.
[13] D. Marr. Vision: A Computational Investigation into the Human Representation and Processing of Visual Information. Henry Holt and Co., Inc., New York, N.Y., USA, 1982.
[14] R. Rosales, K. Achan, and B. J. Frey. Unsupervised image translation. In ICCV, pages 472-478. IEEE Computer Society, 2003.
[16] W. Zhang, C. Cao, S. Chen, J. Liu, and X. Tang. Style transfer via image component analysis. IEEE Transactions on Multimedia, 15(7):1594-1601,2013.
[17] S. C. Zhu, Y. Wu, and D. Mumford. Filters, random fields and maximum entropy (frame): Towards a unified theory for texture modeling. Int. J. Comput. Vision, 27(2):107-126, April 1998.
[18] Criminisi, A., P6rez, P., & Toyama, K. (2004). Region filling and object removal by exemplar-based image inpainting. Image Processing, IEEE Transactions on, 13(9), 1200-1212.
[19] Freeman, W. T., Pasztor, E. C., & Carmichael, O. T. (2000). Learning low-level vision. International journal of computer vision, 40(1), 25-47.
[20] Szeliski, R. (1990). Bayesian modeling of uncertainty in low-level vision. International Journal of Computer Vision, 5(3), 271-301.

1. A method for transferring a style of a reference visual object (E) to an input visual object (I), wherein the method comprises finding a correspondence map ϕ assigning to at least one pixel x in the input visual object a corresponding pixel ϕ(x) in the reference visual object, said finding of a correspondence map ϕ comprising:
quadtree splitting of said input visual object (I) into a plurality of regions Ri, delivering, for at least one region Ri, a set of K candidate labels Li, representing region correspondences between said input visual object (I) and said reference visual object (E); and
obtaining a reduced set of K candidate labels ̂L by using an inference model of Markov Random fields (MRF) type, wherein said MRF inference model is solved by approximating a Maximum a Posteriori using a loopy belief propagation type method, delivering the approximate marginal probabilities for at least one variable of the MRF model.

2. (canceled)

3. The method of claim 1, wherein the stopping criteria for said quadtree splitting depends on a region similarity between the input and reference visual objects.

4. (canceled)

5. The method of claim 3, wherein said region similarity is computed according to a distance between vector representation of a region in the input visual object and vector representation of a region in the reference visual object.

6. The method of claim 3, wherein, for a region Ri for which the stopping criteria is verified, a set of candidate labels is selected by computing the K-nearest neighbors of a region in said reference visual object E corresponding to said region Ri.

7. (canceled)

8. The method of claim 1, wherein finding a correspondence map ϕ comprises replacing at least one region Ri of the input visual object by an corresponding region of said reference visual object, delivering at least one replaced quadtree region Ri.

9. The method of claim 1, wherein finding a correspondence map ϕ comprises applying a bilinear blending on at least one of said replaced quadtree region.

10. The method of claim 9, wherein bilinear blending comprises, for a replaced quadtree region:
obtaining an overlapping quadtree by increasing the size of said replaced quadtree region by an overlap ratio;
computing a blended pixel u′(x) in the output visual object as a linear combination of at least two overlapping intensities at x.

11. The method of claim 1, wherein finding a correspondence map ϕ comprises, for at least one region Ri, selecting (532) corresponding region of said reference visual object, wherein said selecting (532) takes into account the size, the color and/or the shape of said region Ri of said input visual object and/or the size, the color and/or the shape of the corresponding region of said reference visual object.

12. The method of claim 1, wherein a visual object corresponds to an image or a part of an image or a video or a part of a video.

13. An electronic device comprising at least one memory and one or several processors configured for collectively transferring a style of a reference visual object to an input visual object, wherein said one or several processors are configured for collectively:
finding a correspondence map ϕ assigning to at least one pixel x in the input visual objet a corresponding pixel ϕ(x) in the reference visual object, said finding of a correspondence map ϕ comprising:
quadtree splitting of said input visual object (I) into a plurality of regions Ri, delivering, for at least one region Ri, a set of K candidate labels Li, representing region correspondences between said input visual object (I) and said reference visual object (E); and
obtaining a reduced set of K candidate labels AL by using an inference model of Markov Random fields (MRF) type, wherein said MRF inference model is solved by approximating a Maximum a Posteriori using a loopy belief propagation type method, delivering the approximate marginal probabilities for at least one variable of the MRF model.

14. A non-transitory computer readable program product, comprising program code instructions for performing, when said non-transitory software program is executed by a computer, a method for transferring a style of a reference visual object (E) to an input visual object (I), wherein the method comprises finding a correspondence map ϕ assigning to at least one paint pixel x in the input visual object a corresponding pixel ϕ(x) in the reference visual object, said finding of a correspondence map ϕ comprising:
obtaining a reduced set of K candidate labels ̂L by using an inference model of Markov Random fields (MRF) type, wherein said MRF inference model is solved by approximating a Maximum a Posteriori using a loopy belief propagation type method, delivering the approximate marginal probabilities for at least one variable of the MRF model.

15. A computer readable storage medium carrying a software program comprising program code instructions for performing, when said non-transitory software program is executed by a computer, a method according to claim 1.

16. The electronic device of claim 13, wherein the stopping criteria for said quadtree splitting depends on a region similarity between the input and reference visual objects.

17. The electronic device of claim 16, wherein said region similarity is computed according to a distance between vector representation of a region in the input visual object and vector representation of a region in the reference visual object.

18. The electronic device of claim 16, wherein, for a region Ri for which the stopping criteria is verified, a set of candidate labels is selected by computing the K-nearest neighbors of a region in said reference visual object E corresponding to said region Ri.

19. The electronic device of claim 13, wherein finding a correspondence map ϕ comprises replacing at least one region Ri of the input visual object by a corresponding region of said reference visual object, delivering at least one replaced quadtree region Ri.

20. The electronic device of claim 13, wherein finding a correspondence map ϕ comprises applying a bilinear blending on at least one of said replaced quadtree region.

21. The electronic device of claim 13 wherein bilinear blending comprises, for a replaced quadtree region:
obtaining an overlapping quadtree by increasing the size of said replaced quadtree region by an overlap ratio;
computing a blended pixel u′(x) in the output visual object as a linear combination of at least two overlapping intensities at x.

22. The electronic device of claim 13, wherein finding a correspondence map ϕ comprises, for at least one region Ri, selecting a corresponding region of said reference visual object, wherein said selecting takes into account the size, the color and/or the shape of said region Ri of said input visual object and/or the size, the color and/or the shape of the corresponding region of said reference visual object.

23. The electronic device of claim 13 wherein a visual object corresponds to an image or a part of an image or a video or a part of a video.
